(19) United States
(12) Patent Application Publication
(10) Pub. No.: US 2009/0046067 A1
(43) Pub. Date: Feb. 19, 2009

(54) INPUT UNIT, MOBILE TERMINAL HAVING THE SAME, AND METHOD FOR INPUTTING MESSAGE USING THE SAME

(76) Inventor: Jeong Sik IN, Yongin-si (KR)

Correspondence Address: CHA & REITER, LLC, 210 ROUTE 4 EAST STE 103, PARAMUS, NJ, 07652, US

(21) Appl. No.: 12/191,480

(22) Filed: Aug. 14, 2008

(30) Foreign Application Priority Data
Aug. 16, 2007 (KR) 2007-0082363

(51) Int. Cl. G06F 3/02

(52) U.S. Cl. 345/169; 345/168

(57) ABSTRACT

An input unit having a keyboard arrangement allowing efficient input of English words, a mobile terminal having the input unit, and a method for inputting a message using the input unit are provided. The input unit includes a plurality of symbol keys to which a plurality of symbols are sequentially allocated; and at least one selection key for selecting symbols allocated to at least second positions in the symbol keys. The input unit includes the selection key, to reduce the number of selections of keys when alphabet letters are input, thereby reducing the message input time and solving the inconvenience associated with inputting letters of the alphabet via the input unit.

### CLAIM OF PRIORITY

This application claims priority to an application entitled “INPUT UNIT, MOBILE TERMINAL HAVING THE SAME, AND METHOD FOR INPUTTING MESSAGE USING THE SAME,” filed in the Korean Intellectual Property Office on Aug. 16, 2007 and assigned Serial No. 2007-0082363, the contents of which are incorporated herein by reference in its entirety.

### BACKGROUND OF THE INVENTION

1. Field of the Invention

The present invention relates generally to a mobile terminal and a method for performing a function thereof. More particularly, the present invention relates to an input unit having a keyboard arrangement allowing for an efficient input of English words, a mobile terminal having the input unit, and a method for inputting a message using the input unit.

2. Description of the Related Art

There has been tremendous growth in the mobile terminal in part because of new technologies and functions that stimulate consumer's interests. Especially, due to development of new technologies, various applications satisfying the intricate needs of users, as well those providing simple applications are being installed in the mobile terminals.

Accordingly, a user of a mobile terminal can access voice information, letter information, image information, an MP3 (MPEG layer 3), a game, etc.

In particular, a mobile terminal sometimes provides a short message service (SMS) for transferring a letter (i.e. text) message at any time, regardless of the operational state of a mobile terminal of a counterpart. The SMS is a wireless call service allowing easy transfer of the intention of a user to a counterpart mobile user at a relatively low cost. These days, there has been a gradual increase in the use of multimedia messaging services for allowing transmission and reception of data of various types of formats such as a voice, a music, a still image, and a moving image, as well as a text messages.

Meanwhile, since the number of keys provided in an input unit of a mobile phone is limited, a plurality of letters is generally allocated to one key of an alphanumeric keypad.

For example, as illustrated in FIG. 1, in an input unit 120 having a key arrangement of four by three, a plurality of alphabet letters are allocated to keys 121 in the order of the alphabet, respectively. Then, the alphabet letters are allocated to nine keys 121 in rows 1 to 3 among the twelve keys.

However, in the conventional input unit 120, since the alphabet letters are arranged simply in the order of the alphabet, there is a limit in efficiently inputting English words through the input unit 120. That is, it is necessary to select a key 121 to input an alphabet letter allocated to the same key 121 up to a maximum of three times. Furthermore, in order to sequentially input an alphabet letter allocated to the same key 121, it is necessary to wait for a period of time after inputting an alphabet letter at the foremost position in the key 121 or input the next alphabet letter after pressing a direction key, which is bothersome and time-consuming. Vowels are also not at the first position with the exception of the “A” which makes spelling out words even more time consuming.

For example, since all of the alphabet letters are allocated to the nine keys 121 in FIG. 1, the probability of inputting a predetermined alphabet letter using a predetermined key 121 again after inputting the predetermined alphabet letter using the predetermined key is a high value of one ninth (approximately 11%). Especially, since the alphabet letters are arranged in the order of the alphabet, when alphabet letters of high use frequencies are disposed at rear positions in the keys 121, the number of selections of the keys 121 may increase further.

Accordingly, since the input unit 120 having the conventional arrangement of alphabet letters is accompanied by several repeated inputs of keys to input the alphabet letters, it is inconvenient and time-consuming to input an English message. In an attempt to bypass the problem of time consuming keying, text messaging has evolved an abbreviated language of its own. However, not everyone understands the meaning of the abbreviated texts, which can result in a miscommunication or additional time spent by a recipient to decipher an abbreviated message.

### SUMMARY OF THE INVENTION

The present invention has been made at least in part in view of the above problems, and provides advantages as discussed herein below. Accordingly the present invention provides a mobile terminal and a method for performing a function thereof that allow for efficient input of a symbol allocated to a key.

The present invention provides a mobile terminal and a method for performing a function thereof that can minimize the number of selections of keys when an alphabet letter is input, thereby speeding up the input time and increasing the ease of use.

In accordance with an exemplary embodiment of the present invention, there is provided an input unit of a mobile terminal having a plurality of keys, the input unit typically comprising: a plurality of symbol keys to which a plurality of symbols are sequentially allocated; and at least one selection key for selecting symbols allocated to at least second positions in the symbol keys and a mobile terminal having the same. It is preferable that the at least one selection key for selecting symbols allocated to at least second positions in the symbol keys is actuated to select a symbol with a number of keystrokes being less than a position number of said at least second positions.

In accordance with another exemplary embodiment of the present invention, there is provided a method for inputting a message using an input unit of a mobile terminal, the method typically comprising: a symbol displaying step of displaying a symbol allocated to a selected symbol key at a first position thereof when one of a plurality of symbol keys, to which a plurality of symbols including the alphabet letters are sequentially allocated, is selected; and a symbol changing step of changing the displayed symbol to one of the symbols allocated to at least second positions of the selected symbol key when a selection key is selected.

In accordance with still another exemplary embodiment of the present invention, there is provided a mobile terminal including an input unit, a display unit, and a control unit. The input unit typically has a plurality of symbol keys to which a plurality of symbols including alphabet letters are sequentially allocated, and at least one selection key for selecting symbols allocated to at least second positions in the symbol keys. The display unit displays a symbol in correspondence to a key selected by the input unit. The control unit displays a symbol allocated to the first position in a selected symbol key when one of the symbol keys is selected and changes the displayed symbol to one of symbols located at least second positions in the selected symbol key when the selection key is selected.

According to the present invention, the input unit preferably has selection keys for selecting symbols including alphabet letters at the second and third positions in symbol keys, so that a user can input all alphabet letters by two or less selections of keys.

In particular, since the input unit sequentially allocates alphabet letters in correspondence to use frequencies of the alphabet letters, a user can efficiently input the alphabet letters, minimizing the number of selections of keys. For example, it can be seen through simulation experiments that the input unit according to the present invention enhances the input efficiency of letters by about 40% as compared with a conventional input unit.

Furthermore, when alphabet letters are allocated in correspondence to the use frequencies thereof in the order of the alphabet, a user familiar with input units having the existing arrangement of the alphabet letters can also use the input unit according to the present invention without an adverse sentiment.

### BRIEF DESCRIPTION OF THE DRAWINGS

The above features and advantages of the present invention will be more apparent from the following detailed description in conjunction with the accompanying drawings, in which:

FIG. 1 is a plan view illustrating an input unit of a conventional mobile terminal;

FIG. 2 is a block diagram illustrating a mobile phone according to an exemplary embodiment of the present invention;

FIGS. 3 to 6 are plan views illustrating exemplary input units having various key arrangements that can be employed in the mobile terminal of FIG. 2;

FIG. 7 is a plan view illustrating an example of the input unit having a key arrangement of four by three as in FIG. 3;

FIG. 8 is a plan view illustrating another example of the input unit having a key arrangement of four by three as in FIG. 3;

FIG. 9 is a graph for comparing the input efficiencies of letters in the input units of FIGS. 1 and 8;

FIG. 10 is a plan view illustrating an example of the input unit having a key arrangement of three by four as in FIG. 4;

FIG. 11 is a plan view illustrating an example of the input unit having a key arrangement of three by four as in FIG. 4;

FIG. 12 is a plan view illustrating an example of the input unit having a key arrangement of two by six as in FIG. 5;

FIG. 13 is a plan view illustrating an example of the input unit having a key arrangement of six by two as in FIG. 6; and

FIG. 14 is a flow chart illustrating a message inputting method using an input unit of a mobile phone according to another exemplary embodiment of the present invention.

### DETAILED DESCRIPTION

Hereinafter, exemplary embodiments of the present invention are described in detail with reference to the accompanying drawings. The same reference symbols are used throughout the drawings to refer to the same or like parts. For the purposes of clarity and simplicity, detailed descriptions of well-known functions and structures incorporated herein may be omitted to avoid obscuring appreciation of the subject matter of the present invention by a person of ordinary skill in the art. Keys arranged in m rows and n columns are expressed by a matrix of m by n (where, m and n are natural integers of at least 2). A row is expressed by Rᵢ, a column is expressed by Cⱼ, and the respective key is expressed by row i and column j or aᵢⱼ (where, i and j are natural integers of 1 to 6).

As illustrated in FIG. 2, a mobile terminal 10 according to an exemplary embodiment of the present invention includes a control unit 11, an input unit 13, a storage unit 15, a wireless communication unit 17, and a display unit 19.

The mobile terminal 10 shown in the exemplary embodiment of the present invention typically comprises a communication terminal capable of transmitting and receiving a message through wireless communication, and may be a mobile phone, a smart phone, a personal digital assistant (PDA), an MP3 player, a portable multimedia player (PMP), and a mobile broadcast receiver such as a digital multimedia broadcasting (DMB) system.

Still referring to FIG. 2, the control unit 11 is a microprocessor performing the overall control operation of the mobile terminal 10. The control unit 11 controls performance of a message input mode.

The input unit 13 provides a plurality of keys 12 and 14 for manipulation of the mobile terminal 10 and generates key data in correspondence to a key selected by a user and transfers the key data to the control unit 11. The input unit 13 includes symbol keys 12 and selection keys 14 that are arranged in a matrix of m by n (where, m and n are natural integers of at least 2). In addition, the input unit 13 may further include function keys such as direction keys and volume keys. Then, a pointing unit such as a keypad and a touch pad and a touch screen can be used as the input unit 13.

The symbol keys 12 are keys to which alphabet letters and special symbols are allocated, and a plurality of symbols are sequentially allocated to the symbol keys 12. The alphabet letters are “A” to “Z” , and the special symbols include at least one of “.”, “,”, and “?”. In the exemplary embodiment of the present invention, two or three symbols are sequentially allocated to the symbol keys 12.

Although alphabet letters and special symbols are allocated to the symbol keys 12 as the symbols, numbers, Korean letters, or other letters, for example, may be allocated and displayed. In this case, symbols including the alphabet letters can be selected through selection of an input symbol.

The selection keys 16, 18 are used for selecting symbols allocated to at least second positions in the symbol keys 12. The selection keys include a first selection key 16 for selecting symbols allocated to the second positions in the symbol keys 12, and a second selection key 18 for selecting symbols allocated to the third positions in the symbol keys 12.

The storage unit 15 typically includes at least one volatile memory device and at least one nonvolatile memory device storing a program necessary for the control of the operation of the mobile terminal 10 and data generated during performance of the program. More particularly, the storage unit 15 also stores a program for executing a message input mode and data generated during performance of the program.

The wireless communication unit 17 transmits and receives wireless communication signals through communication between terminals. For example, the wireless communication unit 17 modulates a message signal output from the control unit 11, converts the frequency of the message signal, and transmits a wireless signal through an antenna, or separates a message signal from a wireless signal received through an antenna, converts the frequency of the message signal, and transmits the message signal to the control unit 11.

With continued reference to FIG. 2, the display unit 19 displays the data stored in the storage unit 15, including various function menus executed in the mobile terminal 10, on a screen. The display unit displays a message input screen necessary for execution of a message input mode. A liquid crystal display (LCD) or a touch screen can be used as the display unit 19. The touch screen performs functions of both a display unit and an input unit.

More particularly, if one of the symbol keys 12 is selected in the message input mode, the control unit 11 displays a symbol allocated to the first position in the selected symbol key 12 on the display unit 19. Thereafter, if one of the selection keys 14 is selected, the control unit 11 changes the displayed symbol to a symbol allocated to the at least second position in the selected symbol key 12, and displays the allocated symbol. Then, if the first selection key 16 is selected, the control unit 11 changes the displayed symbol to a symbol allocated to the second position in the selected symbol key 12. If the second selection key 18 is selected, the control unit 11 changes the displayed symbol to a symbol allocated to the third position in the selected symbol key 12.

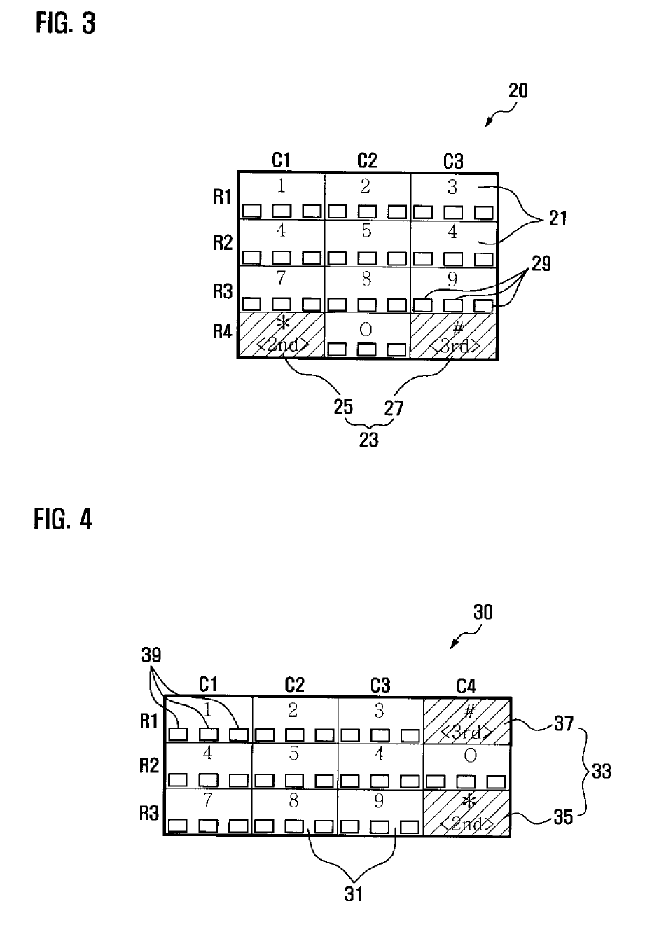

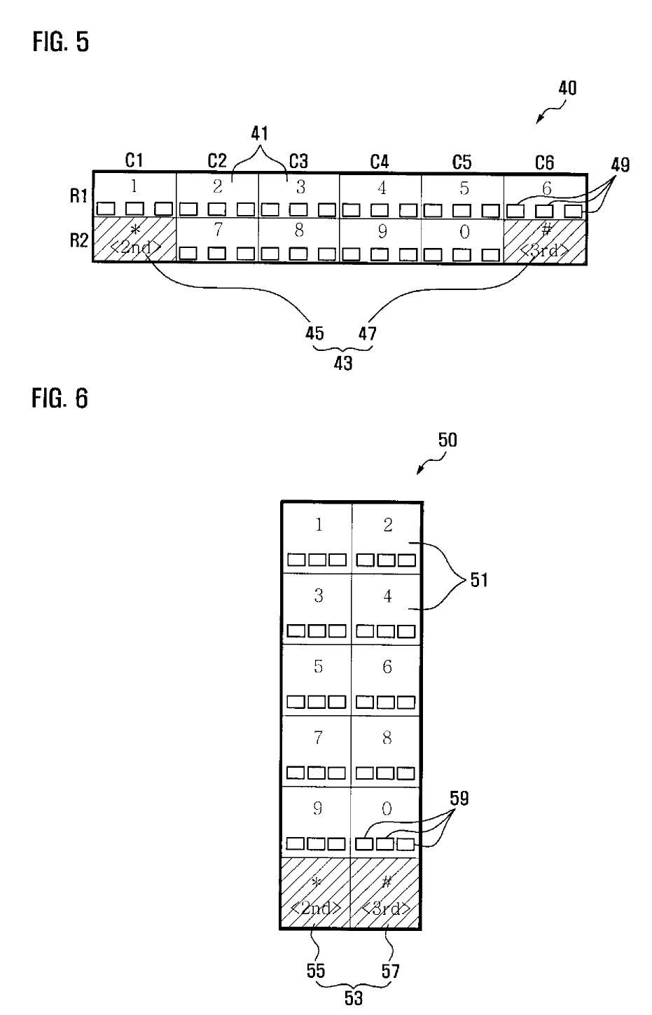

Meanwhile, when the input unit 13 includes ten symbol keys 12 and two selection keys 14, the key arrangement of m by n includes 4 by 3 (FIG. 3), 3 by 4 (FIG. 4), 2 by 6 (FIG. 5), and 6 by 2 (FIG. 6). In FIGS. 3 to 6, although “<2^{nd}>” is displayed on the first selection keys (25, 35, 45, and 55) and “3^{rd}” is displayed on the second selection keys 27, 37, 47, and 57, other patterns may or may not be displayed.

As illustrated in FIG. 3, an input unit 20 having the key arrangement of 4 by 3 uses “a₁₁ to a₃₃ and a₄₂” as the symbol keys 21 and “a₄₁ and a₄₃” as the selection keys 23. Then, a plurality of symbols 29 are sequentially allocated to each of the symbol keys 21. Numbers of “1 to 9 and 0” are sequentially allocated to “a₁₁ to a₃₃ and a₄₂”. In addition, a₄₁ is used as the first selection key 25, and a₄₃ is used as the second selection key 27. Also, “*” and “<2^{nd}>” are displayed on the first selection key 25, and “#” and “<3^{rd}>” are displayed on the second selection key 27.

In the input unit 20 illustrated in FIG. 3, although a₄₁ is used as the first selection key 25 and a₄₃ is used as the second selection key 27, a₄₁ may be used as the second selection key 25 and a₄₃ may be used as the first selection key 27. Thus, the location of the selection keys 23 is riot limited to the exemplary embodiment of the present invention and may be determined in different ways, all of which are within the spirit of the invention and the scope of the appended claims.

As illustrated in FIG. 4, the input unit 30 having the key arrangement of 3 by 4 uses “a₁₄ and a₃₄” as the selection keys 33 and the remaining keys as the symbol keys 31. Then, a plurality of symbols 39 are sequentially allocated to each of the symbol keys 31. In this example, numbers of “1 to 9 and 0” are sequentially allocated to “a₁₁ to a₃₃ and a₂₄”. Moreover, a₁₄ is used as the second selection key 37 and a₃₄ is used as the first selection key 35. Additionally, “*” and “<2^{nd}>” are displayed on the first selection key 35 and “#” and “<3^{rd}>” are displayed on the second selection key 37.

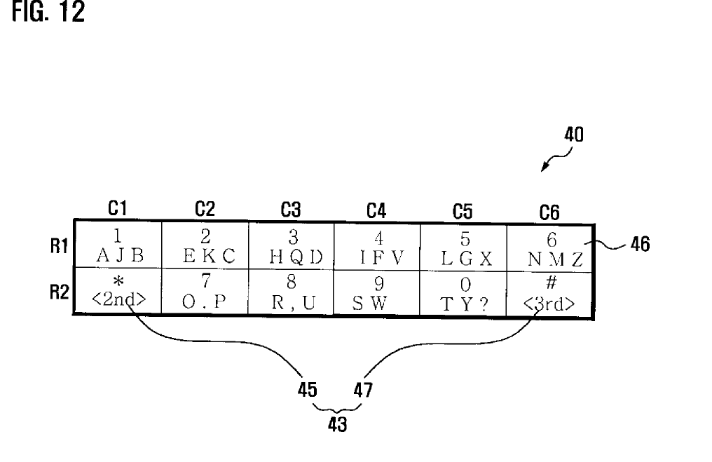

In the input unit 30 illustrated in FIG. 4, although a₁₄ is used as the second selection key 37, and a₃₄ is used as the first selection key 35, a₁₄ may be used as the first selection key and a₃₄ may be used as the second selection key. The location of the selection keys 33 is not limited to the exemplary embodiment of the present invention and may be determined in different ways that are within the spirit of the invention and the scope of the appended claims. For example, as illustrated in the example in FIG. 11, a₃₁ is used as the first selection key 35 and a₃₄ is used as the second selection key 37.

As illustrated in the example in FIG. 5, the input unit 40 may have the key arrangement of 2 by 6, using “a₂₁ and a₂₆” as the selection keys 43 and the remaining keys as the symbol keys 41. Then, a plurality of symbols 49 are sequentially allocated to each of the symbol keys 41. Numbers of “1 to 6” are sequentially allocated to “a₁₁ to a₁₆” and numbers of “7 to 9 and 0” are sequentially allocated to “a₂₂ to a₂₅”. a₂₁ is used as the first selection key 45 and a₂₆ is used as the second selection key 47. “*” and “<2^{nd}>” are displayed on the first selection key 45 and “#” and “<3^{rd}>” are displayed on the second selection key 47.

In the example of input unit 40 illustrated in FIG. 5, although a₂₁ is used as the first selection key 45 and a₂₆ is used as the second selection key 47, a₂₁ may be used as the second selection key and a₂₆ may be used as the first selection key. The location of the selection keys 43 is not limited to the exemplary embodiment of the present invention and may be determined in different ways that is within the spirit of the invention and the scope of the appended claims.

As illustrated in FIG. 6, the input unit 50 having the key arrangement of 6 by 2 uses “a₆₁ and a₆₂” as the selection keys 53 and the remaining keys as the symbol keys 51. Then, a plurality of symbols 59 are sequentially allocated to each of the symbol keys 51. Numbers of “1 to 9 and 0” are sequentially allocated to “a₁₁ to a₅₂”. In addition, a₆₁ is used as the first selection key 55 and a₆₂ is used as the second selection key 57; and “*” and “<2^{nd}>” are displayed on the first selection key 55 and “#” and “<3^{rd}>” are displayed on the second selection key 57.

In the input unit 50 illustrated in FIG. 6, although a₆₁ is used as the first selection key 55 and a₆₂ is used as the second selection key 57, a₆₁ may be used as the second selection key and a₆₂ may be used as the first selection key. The location of the selection keys 53 is not limited to the embodiment of the present invention and may be determined in different ways.

In the input units 10, 30, 40, and 50 having twelve keys, when ten keys are used as the symbol keys 21, 31, 41, and 51 and three or less symbols 29, 39, 49, and 59 are sequentially allocated to the symbol keys 21, 31, 41, and 51 respectively, thirty symbols 29, 39, 49, and 59 can be allocated. The symbols 29, 39, 49, and 59 allocated to the symbol keys 21, 31, 41, and 51 can include twenty six alphabet letters and four or less special symbols.

When a plurality of alphabet letters are allocated to the ten symbol keys 21, 31, 41, and 51, at least one of the following elements can be reflected to allocate the alphabet letters. Then, the reflected elements include a random order, the order of the alphabet letters, the use frequencies of the alphabet letters, and the input efficiency of hand manipulation.

More particularly, “a random order” means that a plurality of alphabet letters are allocated to the symbol keys 21, 31, 41, and 51 at random. Also, “the order of the alphabet letters” means that a plurality of alphabet letters are allocated to the symbol keys 21, 31, 41, and 51 in the order of the alphabet, and “the use frequencies of the alphabet letters” means that a plurality of alphabet letters are allocated to the symbol keys 21, 31, 41, and 51 according to the use frequencies of the alphabet letters. Additionally, “the input efficiency of hand manipulation” means that the symbols are allocated so that the symbol keys 21, 31, 41, and 51 and the selection keys 23, 33, 43, and 53 can be selected by one hand or both hands.

For example, a method using the input efficiency of hand manipulation includes allocating the alphabet letters so that a symbol key 21, 31, 41, and 51 is selected with one hand of a user and a selection key 23, 33, 43, and 53 for selecting the at least second symbol key 21, 31, 41, and 51 is selected with the other hand of the user.

Comparison results about the number of selections of keys during inputs of alphabet letters in an input unit to which alphabet letters are allocated at random without using a selection key as in the conventional technology and an input unit to which alphabet letter are allocated at random and which has at least one selection key are as follows.

When three symbols are sequentially allocated to a predetermined symbol, the probabilities of selecting the symbols allocated to the first to third positions in the key are one third respectively.

Also, in the prior art, when the symbol allocated to the first position in the key is to be input, one selection of the key is necessary, when the symbol allocated to the second position in the key is to be input, two selections of the key are necessary, and when the symbol allocated to the third position in the key is to be input, three selections of the key are necessary. Accordingly, in the case of the conventional input unit, as expressed in Formula 1, two selections of a key is arithmetically necessary to input an arbitrary symbol.

$$\frac{1}{3} \times 1 + \frac{1}{3} \times 2 + \frac{1}{3} \times 3 = 2 \qquad Formula 1$$

On the other hand, in the case of the input unit of the present invention, when the symbol allocated to the first position in the key is to be input, one selection of the key is necessary, and when the symbols allocated to the second and third positions in the key are to be input, two key selections are necessary. In other words, according to the present invention, the inputs of the symbols allocated to the second and third positions in the key are achieved through selections of a symbol key and a selection key.

Accordingly, in the input unit of the present invention, as expressed in Formula 2, according to the present invention 1.67 selections of keys are necessary to input an arbitrary symbol.

$$\frac{1}{3} \times 1 + \frac{1}{3} \times 2 + \frac{1}{3} \times 2 = \frac{5}{3} = 1.67 \qquad Formula 2$$

It can be easily seen that the number of selections of keys in the present invention can be reduced as compared with that of the conventional input unit even if the alphabet letters are allocated to the symbol keys at random. This effect basically can be achieved through employment of the selection keys in the input unit of the present invention.

Further, it can be easily expected that when a plurality of alphabet letters are allocated to ten symbol keys, considering the use frequencies of the alphabet letters and the input efficiency of hand manipulation, the number of key selections can be reduced further as compared with the conventional input unit. Especially, when the alphabet letters are allocated in correspondence to the use frequencies thereof, ten alphabet letters of the first ten highest use frequencies are allocated to the first positions in the symbol keys one by one. The remaining alphabet letters are allocated to the second and third positions of the symbol keys.

The use frequencies of the alphabet letters may be rather different in the field of literature, religion, politics, society, and science. For example, the use frequencies of the alphabet letters used in “The Cambridge Encyclopedia of the English Language-David Crystal (1995)” is in the order of “E, A, T, I, N, O, R, S, L, H, D, C, M, U, F, P, G, B, Y, W, V, K, X, J, Z, and Q” from the first highest use frequency to the last. However, as mentioned above, they may be rather different according to the fields.

In other words, in the field of literature, the alphabet letters of the first to fifth highest use frequencies are “C, a, i, t, and n”, in the field of religion, “e, t, i, a, and n”, and in the field of politics, “e, t, i, a, and n”.

Furthermore, the use frequencies of the alphabet letters used in “The Concise Oxford Dictionary (9^{th} edition, 1995), http:www.askoxford.com/asktheexperts/faq/aboutwords/freqency” is in the order of “E, A, R, I, O, T, N, S, L, C, U, D, P, M, H, G, B, F, Y, W, K, V, X, Z, J, and Q”.

As mentioned above, since the use frequencies of the alphabet letters can be rather different according to offices announcing them or fields, the use frequencies of the alphabet letters disclosed in “The Cambridge Encyclopedia of the English Language-David Crystal (1995)” are used as an example in the exemplary embodiment of the present invention.

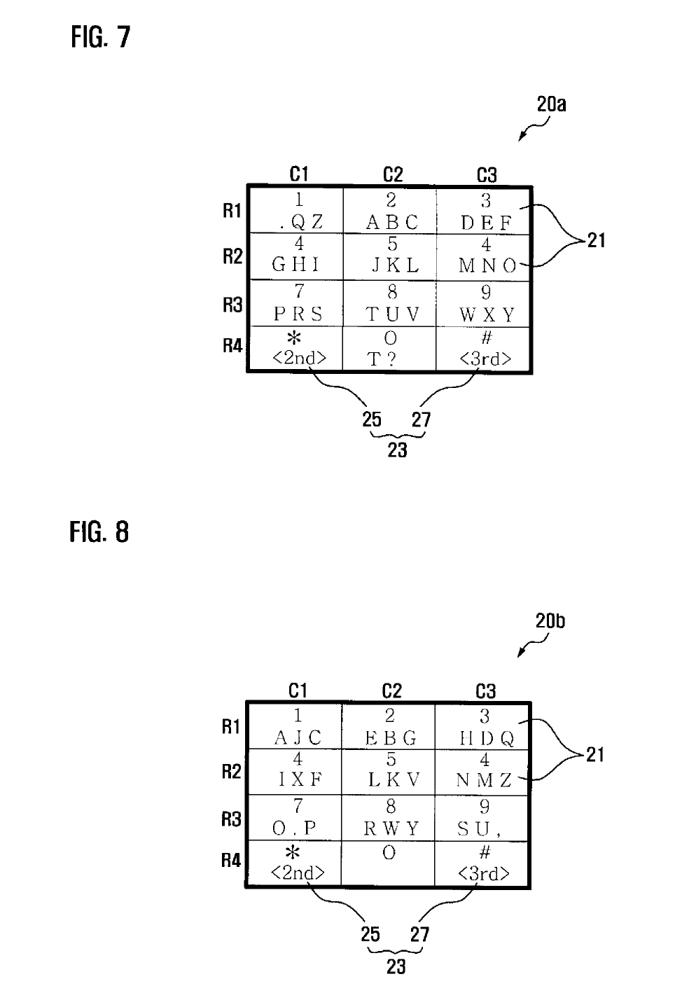

Hereinafter, the input units 20a, 20b, 30a, 30b, 40, and 50 according to the exemplary embodiments of the present invention will be described in detail with reference to FIGS. 7 to 13.

FIGS. 7 and 8 illustrate the input units 20a and 20b having a key arrangement of 4 by 3 according to the exemplary embodiments of the present invention.

Referring to FIG. 7, in the input unit 20a, alphabet letters are allocated to symbol keys 21 in the order of the alphabet. That is, “.”, “Q”, and “Z” are sequentially allocated to a₁₁, and the remaining alphabet letters are allocated to a₁₂ to a₃₃ in the order of the alphabet by three alphabet letters per key. Then, the first selection key 25 is disposed at a₄₁ and the second selection key 27 is disposed at a₄₃.

Referring to FIG. 8, in the input unit 20b, alphabet letters are allocated to the symbol keys 21, considering all of the use frequencies of the alphabet letters, the input efficiency of hand manipulation, and the order of the alphabet.

Ten alphabet letters (E, A, T, I, N, O, R, S, L, and H) of the first ten highest use frequencies are allocated to the first positions in the symbol keys 21 one by one. The alphabet letters of the first ten highest use frequencies may be allocated to the symbol keys 21 in the order of the alphabet. That is, the alphabet letters of the first ten highest use frequencies are allocated to the symbol keys 21 in the order of the alphabet in correspondence to the orders corresponding to the numbers allocated to the symbol keys 21. For example, the ten alphabet letters of the first ten highest use frequencies are allocated to “a₁₁ to a₃₃ and a₄₂” in the order of “A, E, B, I, L, N, O, R, S, and T” respectively.

Although the ten alphabet letters of the first ten highest use frequencies are allocated to the symbol keys 21 in the order of the alphabet, they may be allocated at random or in the order of use frequencies.

The remaining alphabet letters may be allocated to the second or third positions in the symbol keys 21, and may be allocated in the following way.

The six alphabet letters D, C, M, U, F, and P of the second six highest use frequencies are allocated to one of the second or third positions of the symbol keys 21 in column 1 C₁ and the symbol kcys 21 in column 3 C₃ by three alphabet letters per column respectively. Then, since the first selection key 25 is disposed at a₄₁ and the second selection key 27 is disposed at a₄₃, three of the alphabet letters of the second six highest use frequencies may be allocated to the third positions in the symbol keys 21 in column 1 C₁ and the remaining alphabet letters of the second six highest use frequencies may be allocated to the second positions in the symbol keys 21 column 3 C₃. The alphabet letters of the second six highest use frequencies may be allocated to the symbol keys 21 in the order of the alphabet letters. For example, “C, F, and P” are allocated to the third positions in the symbol keys 21 in column 1 C₁ in the order thereof and “D, M, and U” are allocated to the second positions in column 3 C₃.

On the other hand, when the first selection key is located at a₄₃ and the second selection key is located at a₄₁, three of the alphabet letters of the second six highest use frequencies may be allocated to the symbol keys in row 1 and the other three of them may be allocated to the symbol keys in row 3.

Six alphabet letters G, B, Y, W, V, and K of the third six highest use frequencies are allocated to the second and third positions in the symbol keys 21 in column C₂. Then, the alphabet letters of the third six highest use frequencies may be allocated to the second and third positions in the symbol keys 21 in column 2 C₂ by three alphabet letters per position respectively.

Further, the alphabet letters of the third six highest use frequencies may be allocated to the symbol keys 21 in column 2 C₂ in the order of the alphabet. For example, “B, K, and W” are allocated to “a_{12,} a₂₂, and a₃₂” in the order thereof, and “G, V, and Y” are allocated to “a₁₂ a₂₂, and a₃₂” in the order thereof.

Four alphabet letters of the fourth four highest use frequencies may be allocated to the unallocated positions in the symbol keys 21 in column 1 C₁ and column 3 C₃ to which the alphabet letters of the second six highest use frequencies are allocated. The alphabet letters of the fourth four highest use frequencies may be allocated to the symbol keys 21 in the order of the alphabet. For example, “J and X” are allocated to the second positions of a₁₁ and a₂₁ in the order thereof and “Q and Z” are allocated to the third positions of a₁₃ and a₂₃ in the order thereof.

Special symbols may be allocated to the unallocated positions in the symbol keys 21 that remain after the alphabet letters are allocated. For example, “.” is allocated to the second position of a₁₃, “?”, the second position of a₄₂, and “,”, the third position of a₃₃.

Here, the alphabet letters of the first to fourth highest use frequencies are classified by designating the numbers of alphabet letters in correspondence to the use frequencies thereof and may be classified differently according to a key arrangement in the input unit.

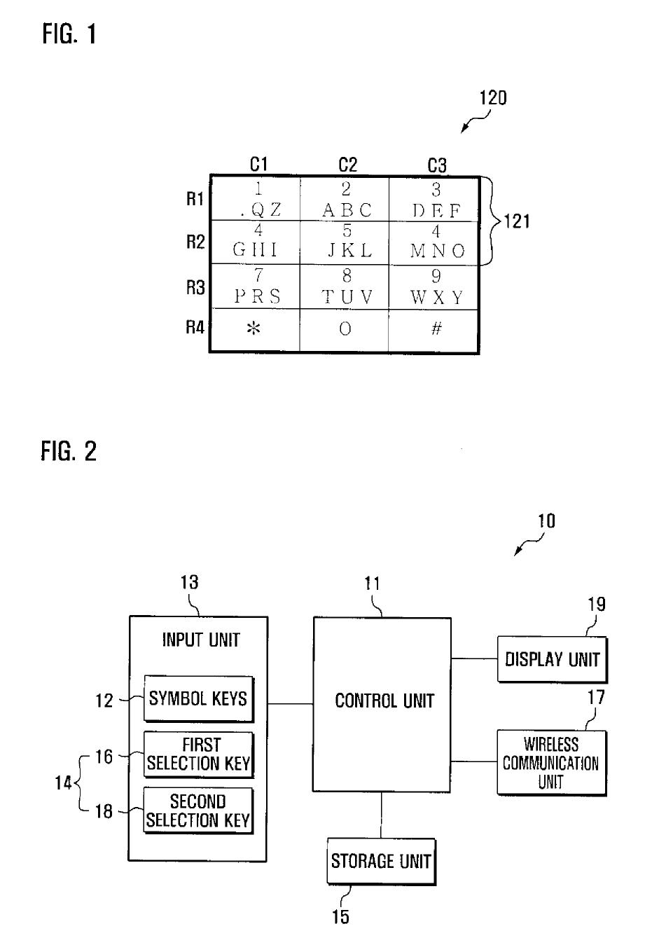

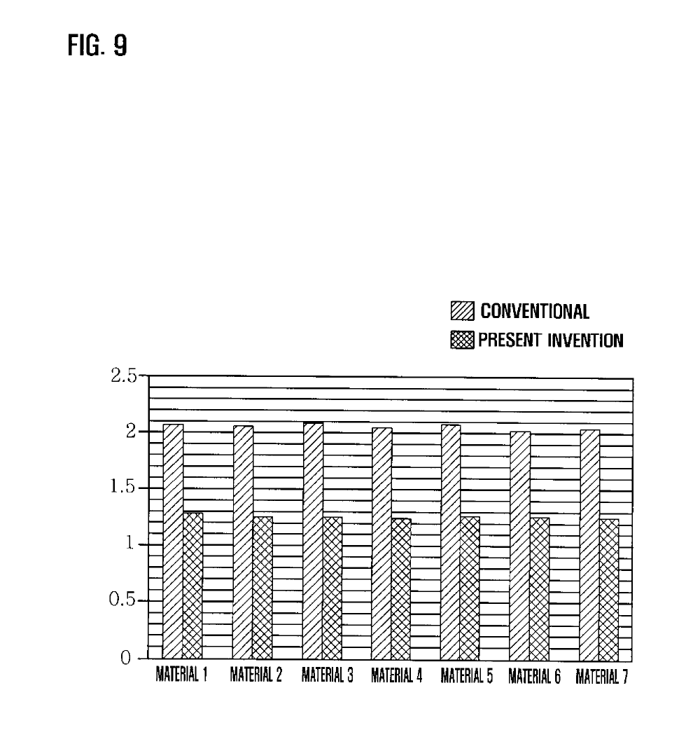

The comparison result of FIG. 9 was obtained through simulation experiments about the numbers of selections of keys of the input unit 20b having the arrangement of alphabet letters of FIG. 8 and the input unit of FIG. 1 during inputs of English words.

In the results based on the simulation experiments shown in FIG. 9, material Nos. 1 to 7 are used as materials for English words. According to the simulation experiments, the conventional input unit 120 required approximately two selections of keys in order to input an arbitrary symbol.

On the other hand, the input unit 20b according to the embodiment of the present invention required approximately 1.2 selections of keys in order to input an arbitrary symbol. Accordingly, it can be seen that the input unit 20b according to the embodiment of the present invention improves the input efficiency by approximately 40 percent as compared with the conventional input unit 120.

Material Nos. 1 to 7 were arbitrarily selected from various fields such as news, articles, medical science, history, literature, and humor, including situation comedy, and a sufficient amount of materials to be statistically important were selected as the objects of the materials.

(1) Material No. 1: the entire script of “Friends Season 1” (257,089 letters)

(2) Material No. 2: arbitrary excerpts format CNN news articles (129,731 letters)

(3) Material No. 3: “Manual of Surgery by Alexander Miles and Alexis Thomson” (977,114 letters)

(4) Material No. 4: “History of the United States by Charles A. Beard and Mary R. Beard” (1,025,076 letters)

(5) Material No. 5: “Fifteen Thousand Useful Phrases by Greenville Kleiser” (438,257 letters)

(6) Material No. 6: “Jokes for All Occasions Selected and Edited by One of America's Foremost Public Speakers” (316,603 letters)

(7) Material No. 7: “Pride and Prejudice by Jane Austen” (547,495 letters)

More particularly, comparison results of the numbers of selections during input of an English word in the input unit 20b of FIG. 8 and the input unit 120 of FIG. 1 are as follows. Here, an English word that is to be input is assumed to be “access”.

In the following description, “number” represents the number displayed on the symbol keys and “>” represents the right direction key.

In the input unit 120 of FIG. 1, a total of eighteen inputs of keys of “2>222>22233777>777” are necessary. On the other hand, in the input unit 20b of FIG. 8, a total of eight inputs of keys of “11#1#299” are necessary. Accordingly, it can be easily seen that the input unit 20b according to the present invention can reduce the number of selections of keys as compared with the conventional input unit 120.

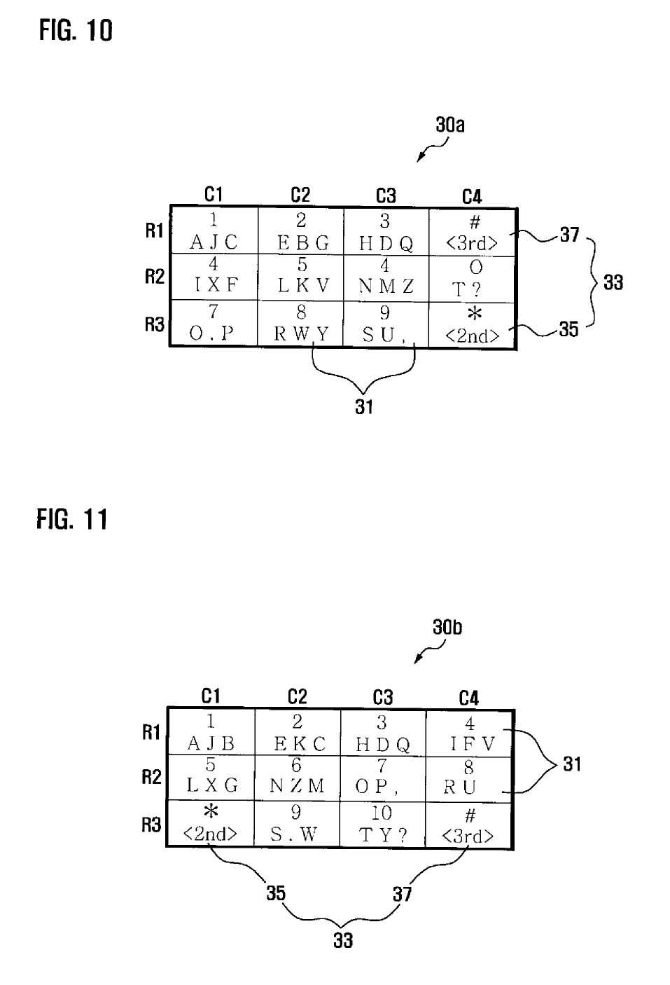

FIGS. 10 and 11 illustrate input units 30a and 30b having a key arrangement of three by four according to exemplary embodiments of the present invention.

Referring to FIG. 10, in the input unit 30a, the alphabet letters are allocated to symbol keys 31, considering all of the use frequencies of the alphabet letters, the input efficiency of hand manipulation, and the order of the alphabet. Especially, considering the symbols allocated to the input unit 30a, the symbol keys 21 and 23 in row 4 R₄ of the input unit 20b of FIG. 8 are moved to the keys 31 and 33 of row 4 R₄. The symbols are allocated to the symbol keys 31 in columns 1 to 3 C₁,C₂, and C₃ as in the symbol keys 21 in columns 1 to 3 C₁,C₂, and C₃ of the input unit 20b of FIG. 8.

The first and second selection keys 35 and 37 are on the right side of the input unit 30a according to the embodiment of the present invention, in which case the first and second selection keys 35 and 37 can be easily manipulated with the right hand of a user.

Although the selection keys 33 are disposed in column C₄ in FIG. 10, the present invention is not limited thereto. That is, as illustrated in FIG. 11, the selection keys 33 may be disposed on both sides of row 3 R₃.

Referring to FIG. 11, the input unit 30b uses a₃₁ and a₃₄ as the selection keys 33 and uses the remaining keys as the symbol keys 31. Here, a plurality of symbols is sequentially allocated to the symbol keys 31. The numbers of “1 to 9 and 0” are sequentially allocated to “a₁₁ to a₂₄, a₃₂ and a₃₃” respectively. In addition, a₃₁ is used as the first selection key and a₃₄ is used as the second selection key 37.

Especially, considering all of the use frequencies of the alphabet letters, the input efficiency of hand manipulation, and the order of the alphabet, a plurality of symbols may be sequentially allocated the symbol keys 31 in the following way.

Ten alphabet letters E, A, T, I, N, O, R, S, L, and H of the first ten highest use frequencies are allocated to the first positions in the symbol keys 31 one by one. The alphabet letters of the first ten highest use frequencies may be allocated to the symbol keys 31 in the order of the alphabet. That is, the alphabet letters of the first ten highest use frequencies are allocated to the symbol keys 31 in the order of the alphabet in correspondence to the numbers allocated to the symbol keys 31. For example, “A, E, H, I, L, N, O, R, S, and T” are allocated to “a₁₁ to a24, a₃₂, and a₃₃” in the order thereof respectively.

Ten alphabet letters D, C, M, U, F, P, G, B, Y, and W of the second ten highest use frequencies are allocated to the symbol keys 31 in columns 1 and 2 C₁, and C₂ and the symbol keys in columns 3 and 4 C₃ and C₄ by five alphabet letters, respectively. Then, since the first selection key 35 is located at a₃₁, the five alphabet letters of the second ten highest use frequencies are allocated to the second positions in the symbol keys 31 in columns 3 and 4 C₃ and C₄. Further, since the first selection key 37 is located at a₃₄, the remaining five alphabet letters of the second ten highest use frequencies are allocated to the third positions in the symbol keys 31 in columns 1 and 2 C₁ and C₂. The alphabet letters of the second ten highest use frequencies may be allocated to the symbol keys 31 in the order of the alphabet.

For example, “B and G” are sequentially allocated to the third positions in the symbol keys 31 in column 1 C₁, “C, M, and W”, to the third positions in the symbol keys 31 in column 2 C₂, “D, P, and Y”, to the second positions in the symbol keys 31 in column 3 C₃, and “F and W”, to the second positions in the symbol keys 31 in column 4 C₄.

On the other hand, when the first selection key is located at a₃₄, five alphabet letters of the second ten highest use frequencies may be allocated to the second positions in the symbol keys in columns 1 and 2. When the second selection key is located at a₃₁, the remaining alphabet letters of the second ten highest use frequencies may be allocated to the third positions in the symbol keys in columns 3 and 4.

The remaining six alphabet letters V, K, X, J, Z, and Q of the third six highest use frequencies are allocated to the unallocated positions in the symbol keys 31. The alphabet letters of the third six highest use frequencies may be allocated to the symbol keys 31 in the order of the alphabet. For example, “J and K” are allocated to the unallocated second positions of a₁₁ and a₂₂, “Q and V”, to the unallocated third positions of a₁₃ and a₁₄, and “X and Z”, to the unallocated second positions of a₂₁ and a₂₂.

Special symbols may be allocated to the positions of the symbol keys 31 that are not allocated even after all the alphabet letters are allocated. For example, “.” is allocated to the second position of a₃₂, “?”, to the third position of a₃₃, and “,”, to the second position of a₂₃.

As illustrated in the example of FIG. 12, alphabet letters are allocated to symbol keys 41 in an input unit 40 having an arrangement of keys of two by six according to an embodiment of the present invention, considering the use frequencies of the alphabet letters, the input efficiency of hand manipulation, and the order of the alphabet.

Ten alphabet letters E, A, T, I, N, O, R, S, L, and H of the first ten highest use frequencies are allocated to the first positions in the symbol keys 41 one by one. The alphabet letters of the first ten highest use frequencies are allocated to the symbol keys 41 in the order of the alphabet. That is, the alphabet letters of the first ten highest use frequencies are allocated to the symbol keys 41 in the order of the alphabet in correspondence to the numbers allocated to the symbol keys 41. For example, “A, E, H, I, L, N, O, R, S, and T” are allocated to “a₁₁ to a₁₆ and a₂₂ to a₂₅” one by one in the order thereof.

Ten alphabet letters D, C, M, U, F, P, G, B, Y, and W of the second ten highest use frequencies are allocated to the symbol keys 41 in columns 1 to 3 C₁, C₂, and C₃ and the symbol keys 41 in columns 4 to 6 C₄, C₅, and C₆ by five alphabet letters, respectively. Then, since the first selection key 45 is located at a₂₁, the five alphabet letters of the second ten highest use frequencies are allocated to the second positions in the symbol keys 41 in columns 4 to 6 C₄, C₅, and C₆.

Furthermore, since the second selection key 47 is located at a₂₆, the remaining five alphabet letters of the second ten highest use frequencies are allocated to the third positions in the symbol keys 41 in columns 1 to 3 C₁, C₂, and C₃. The alphabet letters of the second ten highest use frequencies may be allocated to the symbol keys 41 in the order of the alphabet. For example, “B, C, D, P, and U” are allocated to “a₁₁, a₁₂, a₁₃, a₂₂, and a₂₃” in the order thereof one by one. “F, G, M, W, and Y” are allocated to “a₁₄, a₁₅, a₁₆, a₂₄, and a₂₅” in the order thereof one by one.

On the other hand, when the first selection key is located at a₂₆, five alphabet letters of the second ten highest use frequencies may be allocated to the second positions in the symbol keys 41 in columns 1 to 3. When the second selection key is located at a₂₁, the remaining alphabet letters of the second ten highest use frequencies may be allocated to the third positions in the symbol keys 41 in columns 4 to 6.

The remaining six alphabet letters V, K, X, J, Z, and Q of the third six highest use frequencies are allocated to the unallocated positions in the symbol keys 41. Then, the alphabet letters of the third six highest use frequencies may be allocated to the symbol keys 41 in the order of the alphabet. For example, “J, K, Q, V, X, and Z” are allocated to the unallocated second positions of a₁₁ and a₁₆ in the order thereof one by one.

Special symbols may be allocated to the positions of the symbol keys 41 that are not allocated even after all the alphabet letters are allocated. For example, “.” is allocated to the second position of a₂₂, “?”, to the second position of a₂₃, and “,”, to the second position of a₂₅.

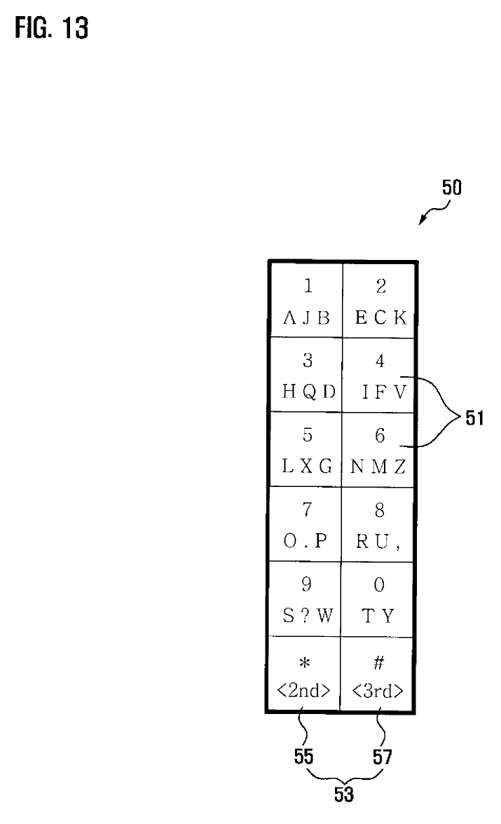

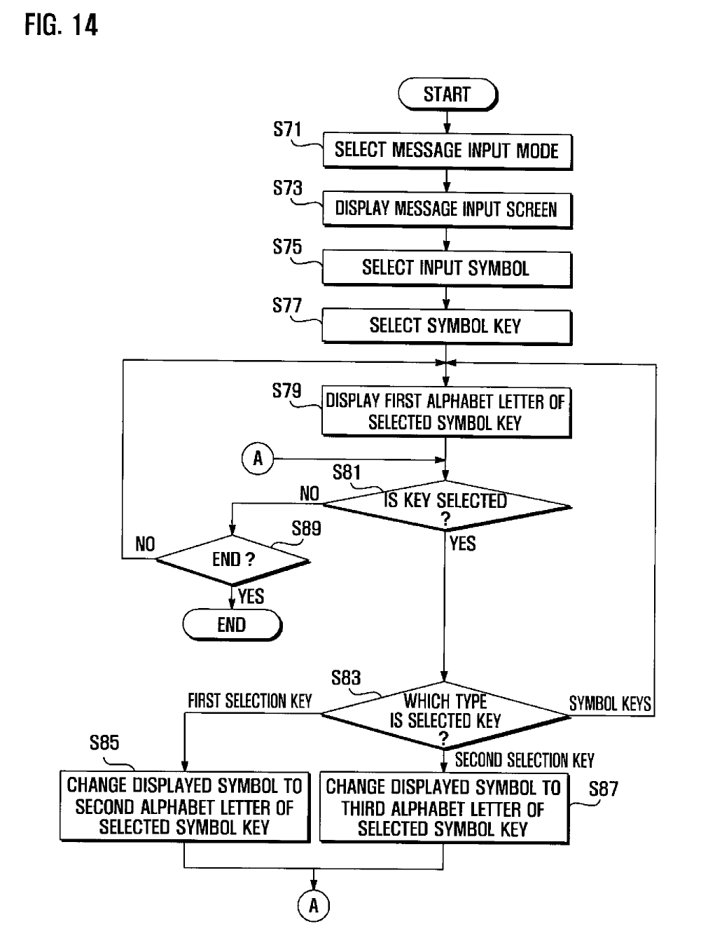

As illustrated in FIG. 13, alphabet letters are allocated to symbol keys 51 in an input unit 50 having an arrangement of keys of six by two according to an exemplary embodiment of the present invention, considering the use frequencies of the alphabet letters, the input efficiency of hand manipulation, and the order of the alphabet.

Ten alphabet letters E, A, T, I, N, O, R, S, L, and H of the first ten highest use frequencies are allocated to the first positions in the symbol keys 51 one by one, and are allocated in the same way as the allocation manner of FIG. 3 in which case detailed description of the allocation method according to the exemplary embodiment of the present invention will be omitted.

Ten alphabet letters D, C, M, U, F, P, G, B, Y, and W of the second ten highest use frequencies are allocated to the symbol keys 51 in columns 1 and 2 C₁ and C₂ by five alphabet letters per column, respectively. Then, since the first selection key 55 is located at a₆₁, the five alphabet letters of the second ten highest use frequencies are allocated to the second positions in the symbol keys 51 in column 2 C₂. Further, since the second selection key 57 is located at a₆₂, the remaining five alphabet letters of the second ten highest use frequencies are allocated to the third positions in the symbol keys 51 in column 1 C₁. The alphabet letters of the second ten highest use frequencies may be allocated to the symbol keys 51 in the order of the alphabet. For example, “B, D, G, P, and W” are allocated to “a₁₁, a₂₂, a₃₁, a₄₁, and a₅₁” in the order thereof one by one. “C, F, M, U, and Y” are allocated to “a₁₂, a₂₂, a₃₂, a₄₂, and a₅₂” in the order thereof one by one.

On the other hand, when the first selection key is located at a₆₂, five alphabet letters of the second ten highest use frequencies may be allocated to the second positions in the symbol keys 51 in column 1. When the second selection key is located at a₆₁, the remaining alphabet letters of the second ten highest use frequencies may be allocated to the third positions in the symbol keys 51 in column 2.

The remaining six alphabet letters V, K, X, J, Z, and Q of the third six highest use frequencies are allocated to the unallocated positions in the symbol keys 51. Then, the alphabet letters of the third six highest use frequencies may be allocated to the symbol keys 51 in the order of the alphabet. For example, “J, K, Q, V, X, and Z” are allocated to all and a₃₂ in the order thereof one by one.

Special symbols may be allocated to the positions of the symbol keys 51 that are not allocated even after all the alphabet letters are allocated. For example, “.” is allocated to the second position of a₄₁, “,”, to the third position of a₄₂, and “?”, to the second position of a₅₁.

Hereinafter, a method for inputting a message using the input unit 13 of the mobile terminal 10 according to an exemplary embodiment of the present invention will be described in detail with reference to FIGS. 1 to 13.

Now referring to the flowchart of FIG. 13, if a message input mode is selected in correspondence to selection of a key by a user (S71), the control unit 11 executes the message input mode and displays a message input screen on the display unit 19 (S73). A user can select input symbols necessary for input of a message through selection of keys. The input symbols that can be selected by a user include alphabet letters, numbers, and special symbols. In the exemplary embodiment of the present invention, alphabet letters are selected as the input symbols for inputting an English word.

Thereafter, if one of the plurality of symbol keys 12 in the input unit 13 is selected through input of a key by a user (S77), an alphabet letter allocated to the first position in the selected symbol key 12 is displayed (S79).

Thereafter, the control unit 11 determines whether a symbol key 12 or one of selection keys 14 is selected (S81). After the determination in the step S81, if a key is determined to be selected, the control unit 11 determines the type of the selected key (S83). The selected key may be one of the symbol key 12, the first selection key 16, and the second selection key 18.

If the first selection key 16 is determined to be selected in the step S83, the control unit 11 changes the alphabet letter displayed in the step S79 to the second alphabet letter in the symbol key 12 selected in the step S77 and displays the changed alphabet letter (S85).

If the second selection key 18 is determined to be selected in the step S83, the control unit 11 changes the alphabet letter displayed in the step S79 to the third alphabet letter in the symbol key 12 selected in the step S77 (S85).

Further, if the symbol key 12 is determined to be selected in the step S83, the control unit 11 displays the first alphabet letter in the selected symbol key 12 again next to the alphabet letter displayed in the step of S79.

After performing the steps S85 and S87, the control unit 11 performs the step S81 again. If none of the symbol key 12 and the selection keys 14 is determined to be selected in the step S81, the control unit 11 determines whether the message input mode is to be completed (S89). The control unit 11 can repeat the steps S79 to S87 until the message input mode is completed.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims. For example, although input units having ten symbol keys and two selection keys are disclosed in the exemplary embodiments of the present invention, the number of symbol keys may be either more than or less than ten.

What is claimed is:

1. An input unit comprising:
a plurality of symbol keys to which a plurality of symbols including alphabet letters are sequentially allocated;
at least one selection key for selecting symbols allocated to at least second positions in the symbol keys
a display unit for displaying a symbol in correspondence to a key selected by the input unit; and
a control unit for controlling the display of symbol allocated to the first position in a selected symbol key when one of the plurality of symbol keys is selected and for changing the displayed symbol to one of the symbols located in at least second positions in the selected symbol key when the selection key is selected.

2. The input unit of claim 1, wherein the plurality of symbols comprise alphabet letters.

3. The input unit of claim 2, wherein the plurality of symbols further comprise at least one special symbol.

4. The input unit of claim 3, wherein the at least one selection key comprises:
a first selection key for selecting symbols allocated to the second positions in the symbol keys; and
a second selection key for selecting symbols allocated to the third positions in the symbol keys.

5. The input unit of claim 4, wherein the symbol keys and the first and second selection keys comprise twelve keys and have a key arrangement of m by n (where m and n are natural numbers of two or more than two).

6. The input unit of claim 5, wherein the alphabet letters allocated to the symbol keys are allocated in correspondence to the use frequencies thereof.

7. The input unit of claim 6, wherein ten alphabet letters of the first ten highest use frequencies are allocated to the first positions in the symbol keys, respectively.

8. The input unit of claim 7, wherein the alphabet letters of the first ten highest use frequencies are allocated to the symbol keys at random, in correspondence to the use frequencies thereof, or in the order of the alphabet.

9. The input unit of claim 7, wherein the symbol keys and the first and second selection keys have a key arrangement of 4 by 3, and the first and second selection keys are located at row 4 and column 1 and row 4 and column 3 of the key arrangement respectively.

10. The input unit of claim 7, wherein the symbol keys and the first and second selection keys have a key arrangement of 3 by 4, and the first and second selection keys are located at one of row 1 and column 4 and row 4 and column 4 and one of row 3 and column 1 and row 3 and column 4 of the key arrangement respectively.

11. The input unit of claim 7, wherein the symbol keys and the first and second selection keys have a key arrangement of 2 by 6, and the first and second selection keys are located at row 2 and column 1 and row 2 and column 6 respectively.

12. The input unit of claim 7, wherein the symbol keys and the first and second selection keys have a key arrangement of 6 by 2, and the first and second selection keys are located at row 6 and column 1 and row 6 and column 2 respectively.

13. The input unit of claim 9, wherein six alphabet letters of the second six highest use frequencies are allocated to the second or third positions in the symbol keys located in column 1 and column 3 by three alphabet letters per column respectively.

14. The input unit of claim 13, wherein when the first selection key is located at row 4 and column 1 and the second selection key is located at row 4 and column 3, three of the alphabet letters of the second six highest use frequencies are allocated to the third positions in the keys located in column 1 and the other three of the alphabet letters of the second six highest use frequencies are allocated to the second positions in the keys located in column 3.

15. The input unit of claim 13, wherein when the first selection key is located at row 4 and column 3 and the second selection key is located at row 4 and column 1, three of the alphabet letters of the second six highest use frequencies are allocated to the second positions in the keys located in column 1 and the other three of the alphabet letters of the second six highest use frequencies are allocated to the third positions in the keys located in column 3.

16. The input unit of claim 14, wherein six alphabet letters of the third six highest use frequencies are allocated to the second and third positions in the symbol keys located in column 2.

17. The input unit of claim 16, wherein four alphabet letters of the fourth four highest use frequencies are allocated to the symbol keys in column 1 and column 3, to which the alphabet letters of the second six highest use frequencies are allocated, in the order of the unallocated positions in the symbol keys in column 1 and column 3.

18. The input unit of claim 17, wherein the alphabet letters of the first ten highest use frequencies are A, E, H, I, L, N, O, R, S, and T, the alphabet letters of the second six highest use frequencies, C, D, F, M, P, and U, the alphabet letters of the third six highest use frequencies, B, G, K, V, W, and Y, and the alphabet letters of the fourth four highest use frequencies, J, Q, X, and Z.

19. The input unit of claim 18, wherein the special symbol comprises at least one of “.”, “,”, and “?”.

20. A mobile terminal having an input unit of one of claim 1.

21. A mobile terminal having an input unit of claim 16.

22. The mobile terminal of claim 21, wherein four alphabet letters of the fourth four highest use frequencies are allocated to the symbol keys in column 1 and column 3, to which the alphabet letters of the second six highest use frequencies are allocated, in the order of the unallocated positions in the symbol keys in column 1 and column 3.

23. The mobile terminal of claim 22, wherein the alphabet letters of the first highest ten use frequencies are A, E, H, I, L, N, O, R, S, and T, the alphabet letters of the second six highest use frequencies, C, D, F, M, P, and U, the alphabet letters of the third six highest use frequencies, B, G, K, V, W, and Y, and the alphabet letters of the fourth four highest use frequencies, J, Q, X, and Z.

24. The mobile terminal of claim 23, wherein the special letter comprises at least one of “,”, “,”, and “?”.

25. A method for inputting a message using an input unit of a mobile terminal, the method comprising:
a symbol displaying step of displaying a symbol allocated to a selected symbol key at a first position thereof when one of a plurality of symbol keys, to which a plurality of symbols including the alphabet letters are sequentially allocated, is selected; and
a symbol changing step of changing the displayed symbol to one of the symbols allocated to at least second positions of the selected symbol key when a selection key is selected, wherein a number of times the selection key is actuated to select a particular symbol in one of said at least second positions is less than a position number of said particular symbol.

26. The method of claim 25, wherein the selection key comprises:
a first selection key for selecting symbols allocated to the second positions in the symbol keys; and
a second selection key for selecting symbols allocated to the third positions in the symbol keys.

27. The method of claim 26, wherein in the symbol changing step, when the first selection key is selected, the displayed symbol is changed to a symbol allocated to the second position of the selected symbol key.

28. The method of claim 26, wherein in the symbol changing step, when the second selection key is selected, the displayed symbol is changed to a symbol allocated to the third position of the selected symbol key.
